(19) United States
(12) Patent Application Publication
(10) Pub. No.: US 2025/0110457 A1
(43) Pub. Date: Apr. 3, 2025

(54) METHODS AND APPARATUS FOR ARTIFICIAL INTELLIGENCE CONTROL OF PROCESS CONTROL SYSTEMS

(71) Applicant: Fisher-Rosemount Systems, Inc., Round Rock, TX (US)

(72) Inventors: Shaobo Qiu, Cedar Park, TX (US); Gary K. Law, Georgetown, TX (US); Claudio Aun Fayad, Austin, TX (US); Mark Nixon, Thorndale, TX (US)

(21) Appl. No.: 18/904,853

(22) Filed: Oct. 2, 2024

Related U.S. Application Data
(60) Provisional application No. 63/587,420, filed on Oct. 2, 2023.

(51) Int. Cl. G05B 13/04; G05B 13/02

(52) U.S. Cl. CPC G05B 13/048; G05B 13/0275; G05B 13/042

(57) ABSTRACT

Methods and apparatus for artificial intelligence control of process control systems are described. An example non-transitory machine readable storage medium comprising instructions to cause programmable circuitry to at least: collect a measurement of an operation of a process; utilize machine learning based on a state of the process and a goal function that references one or more measurement(s); and modify operation of a controller based on the machine learning.

### FIELD OF THE DISCLOSURE

This disclosure relates generally to process control systems and, more particularly, to methods and apparatus for artificial intelligence control of process control systems.

### BACKGROUND

Process control systems are used in manufacturing and/or

industrial settings to control processes (e.g., manufacturing processes). During such processes, machines are operated to produce an output. Operators of such process control systems desire to know when particular elements in the process control system are operating out of tolerance, malfunctioning, and/or, more generally, operational statistics of the process control system. Facilities that utilize process control systems may be referred to as process plants, factories, manufacturing facilities, processing facilities, chemical plants, etc.

### BRIEF DESCRIPTION OF THE DRAWINGS

FIG. 1 is a block diagram of an example environment in which an example artificial intelligence (AI) control circuitry operates to facilitate management and operation of a process control system.

FIG. 2 is a set of charts illustrating a process of identifying regions of operation using clustering.

FIG. 3 illustrates a process 300 that may be implemented by the AI control circuitry 104 to utilize reinforcement learning to monitor plant conditions.

FIG. 4 illustrates an example process that may be utilized for tuning parameters of a PID controller using reinforcement learning by the AI control circuitry.

FIG. 5 illustrates an example process for utilizing a reinforcement learning as a controller in a plant process (e.g., in place of a PID controller).

FIG. 6 illustrates an example process that combines the state clustering and reinforcement learning to control a plant.

FIG. 7 is a block diagram of an example processing platform including programmable circuitry structured to execute, instantiate, and/or perform the example machine readable instructions and/or perform the example operations described herein to implement the AI control circuitry of FIG. 1.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

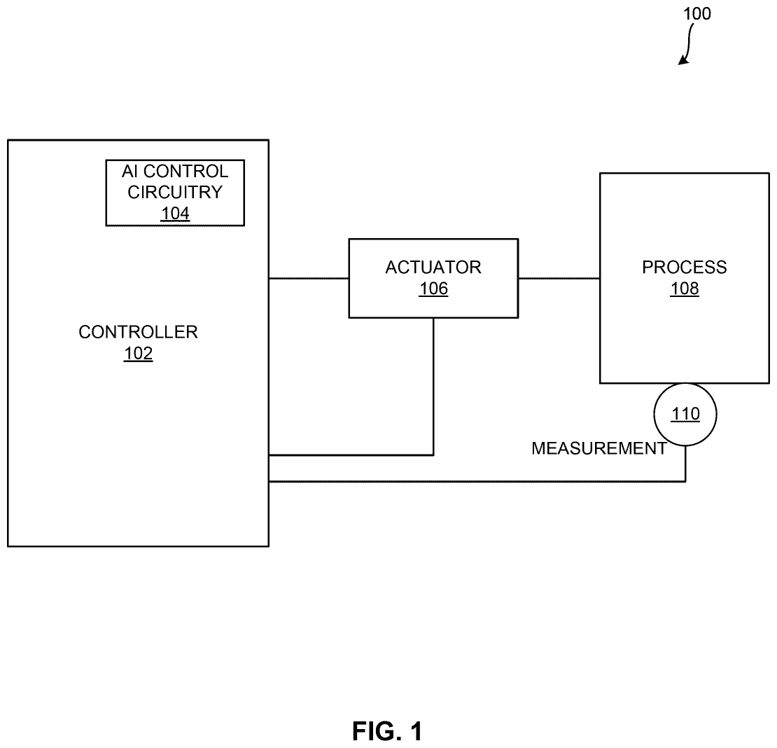

FIG. 1 is a block diagram of an example environment 100 in which an example controller 102 controls operation of an example actuator 106 connected to an example process 108.

The example controller 102 may be any type of controller such as a proportional-integral-derivative (PID) controller, a fuzzy logic controller, etc. The actuator 106 may be any type of actuator for a control system such as a valve, a heater, a switch, etc. The example process 108 is representative of any type of process system that is measured by the example measurement 110. According to the illustrated example, the state of the actuator and the measurement of the process 108 is fed back to the controller 102 to facilitate control of the system by the controller 102.

The example controller 102 includes an example AI control circuitry 104. The AI control circuitry 104 provides end users with a view into their process that continuously updates a model of the process (e.g., for specific loops of the process system). The AI control circuitry 104 utilizes the models to provide one or more of the following:

### Control

PID Tuning—PID parameters of the controller 102 are tuned (either on demand, or continuously). Alternatively, parameters of other types of controllers may be tuned using machine learning. For example, reinforcement learning may be utilized to learn parameters that increase a goal (e.g., move the measurement 110 to a target set point) based on a current condition of the system.

PID augmentation—a bias (Feedforward) may be updated based on the model so that the controller is moved towards Setpoint faster—(e.g., similar to 3 element drum control but with the machine learning model providing the bias)

PID replacement—the model is updated to provide the control of the process control system—(e.g., Similar to model predictive control (MPC), but the model may be updated based on edge analysis). For example, the AI control circuitry 104 may implement the model to replace a traditional controller (e.g., to replace a PID controller) in the environment 100.

Fuzzy Logic Replacement—in this approach, the base control algorithm is Fuzzy Logic and the weightings of the fuzzy logic controller are adapted based on the model used by the AI control circuitry 104.

The AI control circuitry 104 may utilize the machine learning model to control an Outer loop of a cascade loop of an example control system.

The AI control circuitry 104 may perform adjustments to setpoint limits based on the machine learning model as the process moves through different operating states.

The AI control circuitry 104 may perform adjustments to alarm limits, setpoint limits, and rate limits based on the machine learning model as the process moves through different operating states.

### Learning

The AI control circuitry 104 may identify process gains, noise, disturbances, etc. based on learning via the machine learning models.

The AI control circuitry 104 may identify other loops affected by ‘this’ loop based on machine learning.

The AI control circuitry 104 may follow oscillations as they move through the process to learn characteristics that may be utilized to more efficiently control the process.

The AI control circuitry 104 may utilize models to detect and identify changes in material properties that may affect the operation of the example process.

### Recommendations

The AI control circuitry 104 may identify and report changes to the example controller 102 (e.g., recommending what kind of tuning should be used, recommending regions that should be used, identifying seasonality effects, etc.).

The AI control circuitry 104 may identify alarm limits that should be adjusted, setpoint limits that should be adjusted, etc.

The AI control circuitry 104 may utilize the models to predict that a process will go unstable if an action not taken in a set number of minutes.

The AI control circuitry 104 may identify actuators (e.g., valves) that are oscillating.

The AI control circuitry 104 may identify actuators (e.g., valves) that are at limits.

The AI control circuitry 104 may utilize the model to detect measurements that appear to be wrong based on other measurements.

### Help

The AI control circuitry 104 may utilize the model to provide default tuning on loops (temperature loops, pressure loops, etc.).

The AI control circuitry 104 may utilize the model to determine suggested parameters that should be shown together on user interfaces.

The AI control circuitry 104 may utilize the model to generate code to solve specific topics using the following process: Generate code, Test, and Deploy.

The AI control circuitry 104 may be performed in the cloud, on premises, or both. The AI control circuitry 104 may include and/or interface with a large language model (LLM) to accept and interpret user input and to get human readable responses to user input.

In some examples, the AI control circuitry 104 provides for on-line continuous analytics of customer control strategies and can provide updates to the control models. In some examples, the AI control circuitry 104 runs the models locally. In some such examples, the models are available for deployment into the control system as new control algorithms—or may be provided to update existing model algorithms. In some examples, the AI control circuitry 104 may pause model adaptation paused when the process is in an abnormal state so that the control models are not “overtuned”. In some examples, the AI control circuitry 104 may identify sources of oscillations in the process, may identify cause-effect scenarios in the process, may identify measurements that may be incorrect, may identify final control elements that are not working as expected, and/or may recommend control improvements.

In some examples, the AI control circuitry 104 provides continuous and/or paused update of models on an Edge appliance (e.g., IoT devices or other devices located between a premises and the cloud) with feedback into the control algorithms. In some examples, the AI control circuitry 104 provides direct control of a process based on an AI generated model, running in a controller directly connected to the process (e.g., not running in layer 3 or higher). For example, the AI control circuitry 104 may replace a PID controller. In some examples, the AI control circuitry 104 may monitor a process, equipment, device, etc. to analyze the overall operation of the process. Based on the operation of the process, the AI control circuitry 104 may provide suggestions regarding improving the process, may answer questions about the process, may assist with operation of the process, and/or may run an LLM locally, in the cloud, or both.

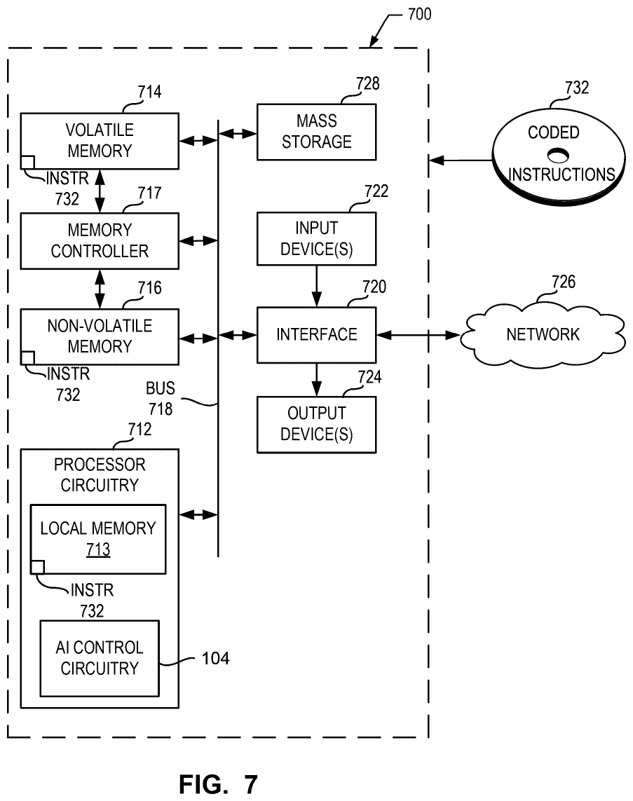

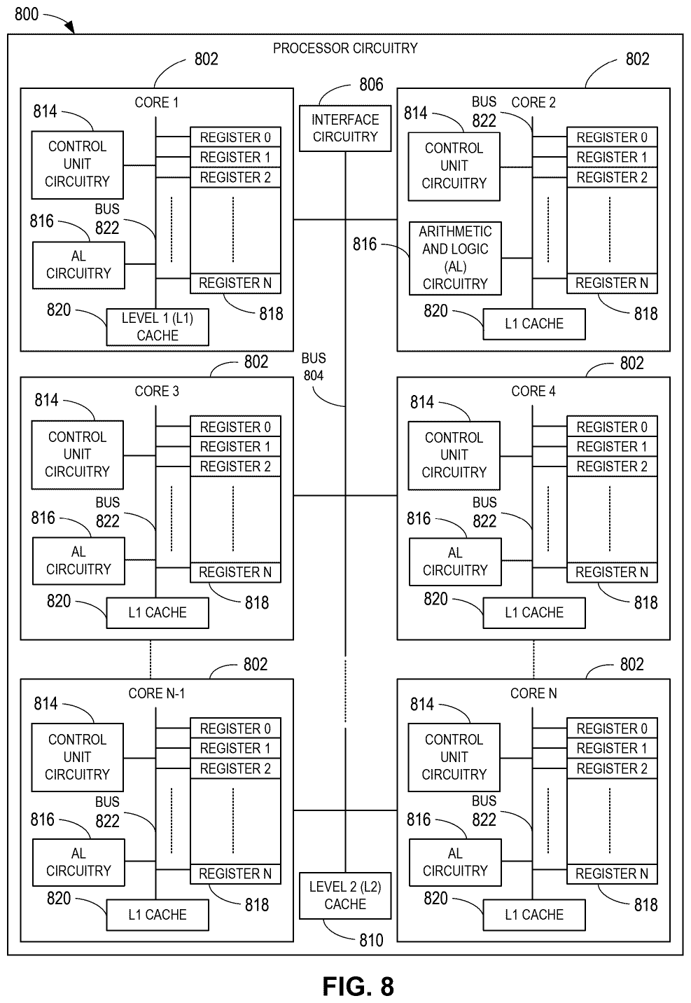

The processes described herein may be implemented machine readable instructions, which may be executed by programmable circuitry to implement and/or instantiate the AI control circuitry 104 of FIG. 1. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

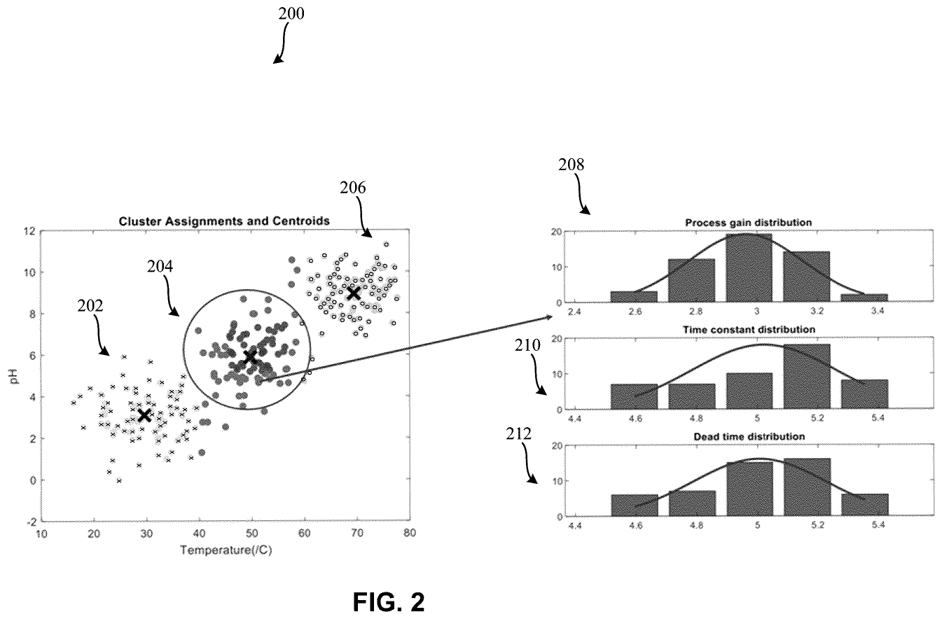

FIG. 2 is a set of charts 200 illustrating a process of identifying regions of operation using clustering.

Operating conditions in process plants vary by throughput as well as other factors. As the plant moves through its plant operations, the AI control circuitry 104 may be divide the operations of the plant into regions of operation. Each region may be called an operating state. For example, the AI control circuitry 104 may break the operating range into equal ranges and then develop a model for each range. Additionally or alternatively, the AI control circuitry 104 may cluster process conditions, such as process gains, time constants, dead time, etc.

FIG. 2 illustrates an example clustering in which the data forms three clusters: a first cluster 202, a second cluster 204, and a third cluster 206. For example, the AI control circuitry 104 may utilize k-means clustering or any other type of clustering. The AI control circuitry 104 may utilize a sliding window of samples and cluster the data to identify the number of clusters, which in turn can be used to identify the current state of the process. For example, the states can be identified using parameters such as throughput, seasonality, or some combination of parameters. The process gains, time constants, and deadtimes may be determined in each operation region. The tuning constants can be optimized for each operating region. FIG. 2 illustrates an example of the process gain distribution 208, example time constant distribution 210, and example dead time distribution 212 for the second cluster 204. After the AI control circuitry 104 identifies the regions, the process may be transitioned from one state to another (e.g., using Low Pass Filters (LPR) or more complex state-based control (SBC) techniques).

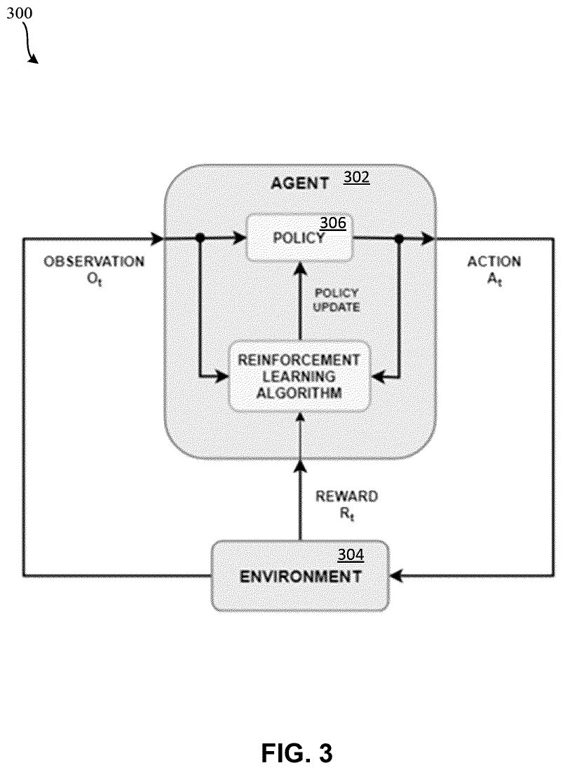

FIG. 3 illustrates a process 300 that may be implemented by the AI control circuitry 104 to utilize reinforcement learning to monitor plant conditions and to detect that the plant is not operating as well as it could. For example, plant conditions may change over time such as, for example, due to seasonality, the regions of operations may change.

As shown in FIG. 2, a computer agent 302 learns to act (i.e., taking action A_t) by interacting with an unknown environment 304 (process plant according to the illustrated example). The agent 302 takes a current observation O_t and updates a policy π_t 306 to maximize a cumulative reward Q_t for a task (e.g., without human intervention or any explicit programs to achieve the task).

### Policy Mapping

A potential action for the agent 302 may be described by a conditional probability π(a,o)=p(Aₜ=a|O+=0). For example, the conditional probability may be the probability of action a given observation o. In an example, A={0,1} where 1 means we tag the state Oₜ as fault/anomaly and 0 means normal.

### Performance Evaluation

A performance of the policy mapping may be measured based on the following formula: V_{π}=Σ_{o∈O}d^{π}(O)EaEAQ(o,a)·π(o,a), where d^{π}(o) is the probability of the target system being in the state o under the utilization of the policy mapping π. According to this action, Q(o,a) represents the accumulated reward started from the observation o with action a. Thus, Q(oₜ, aₜ)=E[Rₜ₊₁+γQ(oₜ₊₁,aₜ₊₁)].

### Optimal Anomaly/Fault Detection Policy Mapping

An optimal policy mapping π satisfies

$${π}^{*} = arg {max}_{π} {V}_{π} .$$

Since d^{π}(o) is roughly the same for all states o, π(o,a) is defined to be 1 if

$$a = arg {max}_{a} Q ( o , a ) .$$

In other words, the optimal policy mapping π* is fully determined by the accumulated reward function Q(o,a).
Learning from Experience E Through Reinforcement Learning

An experience E is a set of tuples, each of which is defined as [symbol] o,a,r,o′ [symbol] and records all the behaviors of the policy mapping π. o,o′ indicate the states of the target system before and after the action a, respectively. r is the instant reward obtained under the state s with the action a. In an anomaly and fault detection system, the actions are decided based on the policy mapping π. In order to improve the policy mapping, the reinforcement learning strategy shown in FIG. 3 is carried out to learn from experience E.

In some examples, the reinforcement learning illustrated by FIG. 3 provides additional options to evaluate the status of process operations and to define normal and abnormal operations during training data preparation. Additionally, in some examples, once training data is obtained without making any assumptions about how well the plant is operating (e.g., whether data are outside the control limits/standard deviation limits), the reinforcement learning (RL) framework can continue to improve its capability with new experience E.

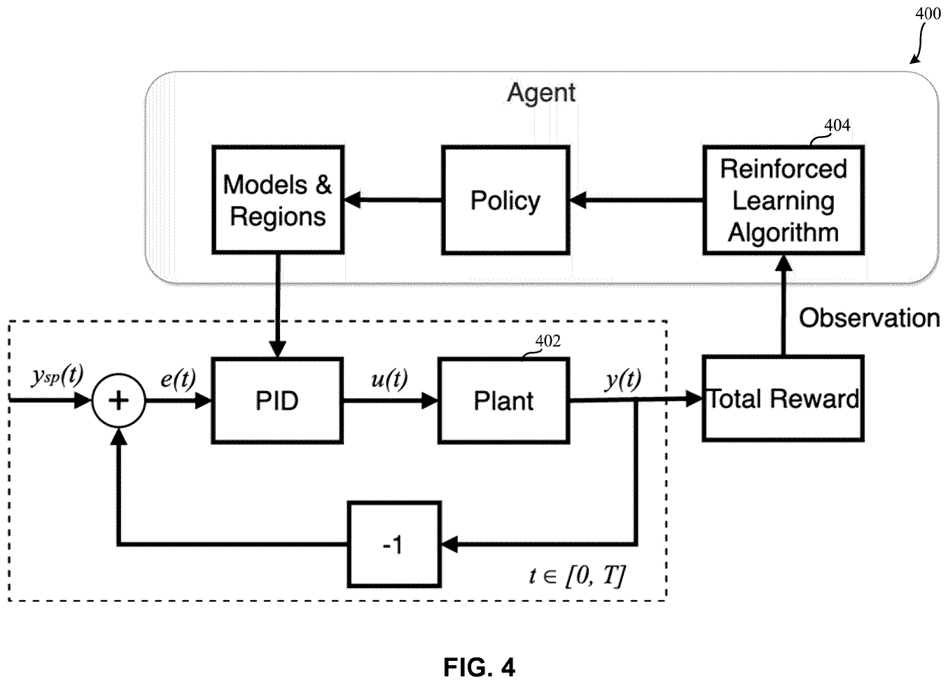

FIG. 4 illustrates an example process 400 that may be utilized for tuning parameters of a PID controller using reinforcement learning by the AI control circuitry 104. The operation of a PID may be improved by adjusting the tuning to be optimized for the region of operation in which a plant is operating. Reinforcement Learning (RL)-based PID tuning leverages the capabilities of RL algorithms to automatically optimize the Proportional-Integral-Derivative (PID) controller parameters (e.g., select parameters that provide improved operating results). Instead of manually tuning the PID gains (Kp, Ki, and Kd), the AI control circuitry 104 may utilize a RL algorithm to explore different configurations and learn from the system's response to achieve the optimal performance.

For each operating region, the example AI control circuitry 104 utilizes a RL routine to discover the optimal PID tuning settings.

### Process Plant Setup

Plant/Process 402 represents a system to be controlled by a PID controller, which can be anything from a simple system to a complex industrial process. The system has a current state, such as a process variable (e.g., temperature, speed, or position) and other signals. An action for the reinforcement learning is an adjustment of the PID parameters (Kp, Ki, Kd). The AI control circuitry 104 chooses actions based on the current state. The reward for the reinforcement learning may be set for metrics of the control system such as minimizing the error, overshoot, rise time, etc.

The RL agent 404 interacts with the process plant by adjusting the PID gains. The agent 404 can be trained using different RL algorithms such as Q-Learning, Deep Q-Networks (DQN), Proximal Policy Optimization (PPO), or others, depending on the complexity of the system.

The goal for the agent 404 is to learn a policy (a strategy) that maps states to actions (PID parameter updates) to maximize the long-term reward. The better the system behaves (e.g., stable, minimal error), the higher the reward. State discovery may be performed using cluster analysis.

Initially, the agent 404 explores the space of PID parameters (e.g., randomly, according to predetermined values, etc.) to gather information about how different configurations affect the system. Over time, the agent 404 transitions to exploiting the knowledge it has gained to adjust the parameters more optimally. In some examples, PID exploration may be performed until the PID parameters (Kp, Ki, Kd) are stable after which time PID tuning may be performed.

The example RL agent 404 is trained over multiple episodes. In each episode, the agent 404 applies different sets of PID gains, observes the system's behavior, and updates its policy based on the reward. The reward function can be designed to penalize large deviations, overshoot, oscillations, limits, and slow response times while rewarding stability and fast settling time.

Reinforcement learning for tuning PID parameters may enable PID tuning without prior knowledge of plant dynamics. Reinforcement learning may be performed without a modeling procedure. As compared with neural network-based reinforcement learning, the example reinforcement learning approach described herein may be performed with minimal hyper-parameter tuning.

In some examples, the AI control circuitry 104 may discover regions of operation for the plant, which includes tuning data, and then switch between tuning models when (1) plant conditions change as noted above using the abnormal behavior routines and (2) a user or second algorithm indicates that it is OK (stable) to start using the new operating region.

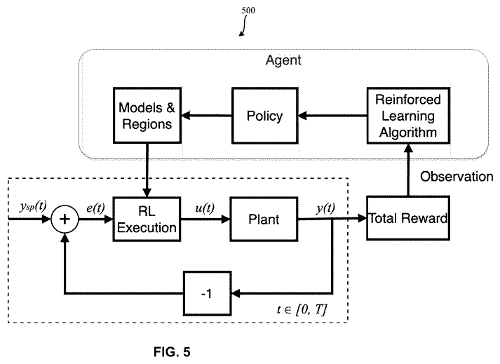

FIG. 5 illustrates an example process 500 for utilizing a reinforcement learning as a controller in a plant process (e.g., in place of a PID controller). Replacing a PID directly with reinforcement learning may lead to improved plant performance. Even in these cases, safeguards may be used to validate that the operation is stable.

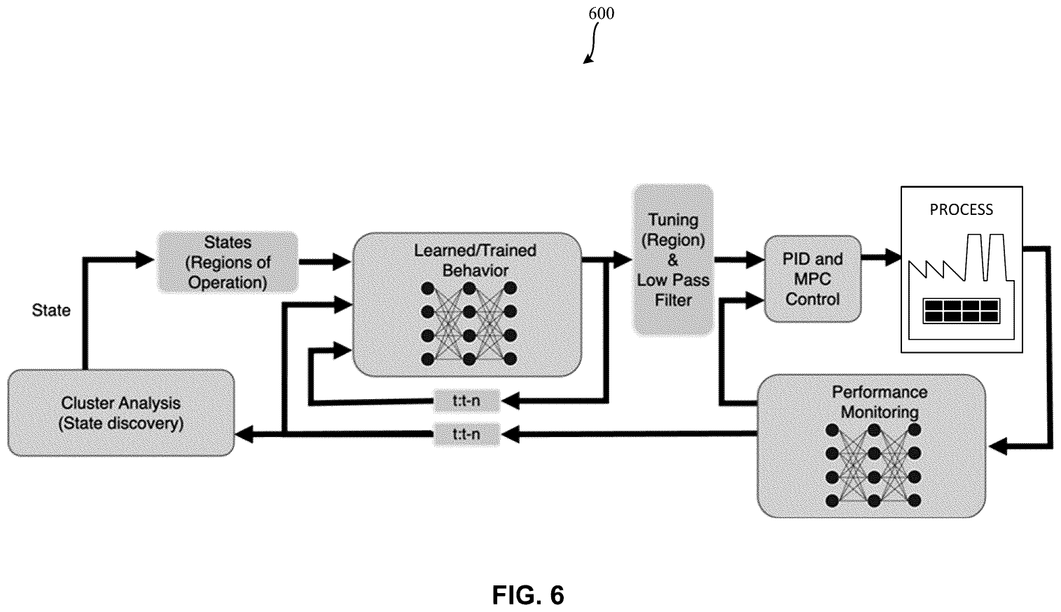

FIG. 6 illustrates an example process 600 that combines the state clustering and reinforcement learning to control a plant. According to the illustrated example, the AI control circuitry 104 may determine states/regions of operation, which information may be provided to a learned behavior system that may provide tuning information based on the state of operation to a PID and/or model predictive control (MPC). A performance monitoring reinforcement learning process may provide feedback to control the operation of the control system based on operating performance of the system.

FIG. 7 is a block diagram of an example programmable circuitry platform 700 structured to execute and/or instantiate the example machine-readable instructions and/or the example operations described herein to implement the AI control circuitry 104 of FIG. 1. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the AI control circuitry 104 of FIG. 1.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732 may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions described herein to effectively instantiate the circuitry of FIG. 7 as logic circuits to perform operations corresponding to those machine readable instructions. In some such examples, the circuitry of FIG. 1 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations described herein.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 7 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8.

Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

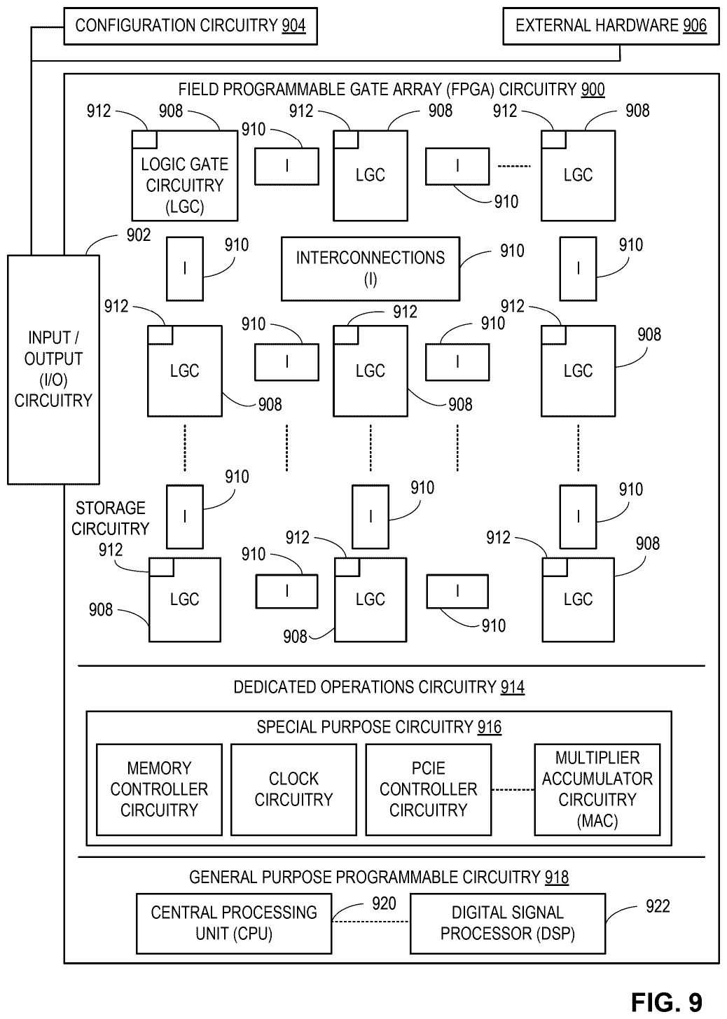

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions described herein but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions described herein. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) described herein. As such, the FPGA circuitry 900 may be configured and/or structured to effectively instantiate some or all of the operations/functions corresponding to the machine readable instructions described herein as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions described herein faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions described herein and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions described herein to perform first operation(s)/function(s), the FPGA circuitry 900 of FIG. 9 may be configured and/or structured to perform second operation(s)/function(s) corresponding to a second portion of the machine readable instructions described herein, and/or an ASIC may be configured and/or structured to perform third operation(s)/function(s) corresponding to a third portion of the machine readable instructions describe herein.

It should be understood that some or all of the circuitry of FIG. 1 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 1 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

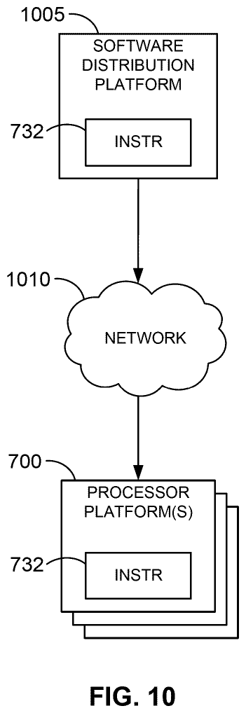

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions described herein, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable described herein, may be downloaded to the example programmable circuitry platform 700, which is to execute the machine readable instructions 732 to implement the AI control circuitry 104. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to methods and apparatus for artificial intelligence control of process control systems are disclosed herein. Further examples and combinations thereof include the following:

Example 1 includes a non-transitory machine readable storage medium comprising instructions to cause programmable circuitry to at least collect a measurement of an operation of a process, utilize machine learning based on a state of the process and a goal function that references one or more measurement(s), and modify operation of a controller based on the machine learning.

Example 2 includes the non-transitory machine readable storage medium as set forth in example 1, wherein the instructions are further to cause the programmable circuitry to determine tuning parameters for a proportional-integral-derivative controller.

Example 3 includes the non-transitory machine readable storage medium as set forth in example 1, wherein the machine learning includes at least one of any type of machine learning algorithm, any type of controller tuning, results from a large language model (LLM), or a reinforcement learning.

Example 4 includes the non-transitory machine readable storage medium as set forth in example 1, wherein the controller is a fuzzy logic controller.

Example 5 includes the non-transitory machine readable storage medium as set forth in example 1, wherein the controller is a machine learning controller that executes a machine learning model to control the operation of the process.

Example 6 includes the non-transitory machine readable storage medium as set forth in example 1, wherein the controller is a proportional-integral-derivative controller.

Example 7 includes the non-transitory machine readable storage medium as set forth in example 1, wherein the controller is a model predictive control (MPC) controller.

Example 8 includes the non-transitory machine readable storage medium as set forth in example 1, wherein a coefficient for the proportional-integral-derivative controller is modified based on the machine learning.

Example 9 includes the non-transitory machine readable storage medium as set forth in example 6, wherein a bias applied to the proportional-integral-derivative controller is modified based on the machine learning.

Example 10 includes the non-transitory machine readable storage medium as set forth in example 1, wherein the machine learning is further based on at least one of gains, noise, or disturbances present in the process.

Example 11 includes the non-transitory machine readable storage medium as set forth in example 1, wherein the instructions, when executed, cause the programmable circuitry to detect an abnormal state of the process.

Example 12 includes the non-transitory machine readable storage medium as set forth in example 11, wherein the instructions, when executed, cause the programmable circuitry to pause model adaptations of the machine learning after the abnormal state is detected.

Example 13 includes the non-transitory machine readable storage medium as set forth in example 1, wherein the instructions, when executed, cause the programmable circuitry to output a recommendation regarding a change to the controller.

Example 14 includes the non-transitory machine readable storage medium as set forth in example 1, wherein the instructions, when executed, cause the programmable circuitry to detect, based on the machine learning, that at least one of an alarm limit or a set point should be modified.

Example 15 includes a method comprising collecting a measurement of an operation of a process, utilizing machine learning based on a state of the process and a goal function that references one or more measurement(s), and modifying operation of a controller based on the machine learning.

Example 16 includes the method as set forth in example 15, wherein modifying operation of the controller includes adjusting tuning parameters for a proportional-integral-derivative controller.

Example 17 includes the method as set forth in example 15, wherein the machine learning includes at least one of any type of machine learning algorithm, any type of controller tuning, results from a large language model (LLM), or a reinforcement learning.

Example 18 includes the method as set forth in example 15, wherein the controller is a fuzzy logic controller.

Example 19 includes the method as set forth in example 15, wherein the controller is a machine learning controller that executes a machine learning model to control the operation of the process.

Example 20 includes the method as set forth in example 15, wherein the controller is a proportional-integral-derivative controller.

Example 21 includes the method as set forth in example 15, wherein the controller is a model predictive control (MPC) controller.

Example 22 includes the method as set forth in example 20, wherein a coefficient for the proportional-integral-derivative controller is modified based on the machine learning.

Example 23 includes the method as set forth in example 20, wherein a bias applied to the proportional-integral-derivative controller is modified based on the machine learning.

Example 24 includes the method as set forth in example 15, wherein the machine learning is further based on at least one of gains, noise, or disturbances present in the process.

Example 25 includes the method as set forth in example 15, further comprising detecting an abnormal state of the process.

Example 26 includes the method as set forth in example 25, further comprising pausing model adaptations of the machine learning after the abnormal state is detected.

Example 27 includes the method as set forth in example 15, further comprising outputting a recommendation regarding a change to the controller.

Example 28 includes the method as set forth in example 15, further including detecting, based on the machine learning, that at least one of an alarm limit or a set point should be modified.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine readable storage medium comprising instructions to cause programmable circuitry to at least:
collect a measurement of an operation of a process;
utilize machine learning based on a state of the process and a goal function that references one or more measurement(s); and
modify operation of a controller based on the machine learning.

2. The non-transitory machine readable storage medium as set forth in claim 1, wherein the instructions are further to cause the programmable circuitry to determine tuning parameters for a proportional-integral-derivative controller.

3. The non-transitory machine readable storage medium as set forth in claim 1, wherein the machine learning includes at least one of any type of machine learning algorithm, any type of controller tuning, results from a large language model (LLM), or a reinforcement learning.

4. The non-transitory machine readable storage medium as set forth in claim 1, wherein the controller is a fuzzy logic controller.

5. The non-transitory machine readable storage medium as set forth in claim 1, wherein the controller is a machine learning controller that executes a machine learning model to control the operation of the process.

6. The non-transitory machine readable storage medium as set forth in claim 1, wherein the controller is a proportional-integral-derivative controller.

7. The non-transitory machine readable storage medium as set forth in claim 1, wherein the controller is a model predictive control (MPC) controller.

8. The non-transitory machine readable storage medium as set forth in claim 1, wherein a coefficient for the proportional-integral-derivative controller is modified based on the machine learning.

9. The non-transitory machine readable storage medium as set forth in claim 6, wherein a bias applied to the proportional-integral-derivative controller is modified based on the machine learning.

10. The non-transitory machine readable storage medium as set forth in claim 1, wherein the machine learning is further based on at least one of gains, noise, or disturbances present in the process.

11. The non-transitory machine readable storage medium as set forth in claim 1, wherein the instructions, when executed, cause the programmable circuitry to detect an abnormal state of the process.

12. The non-transitory machine readable storage medium as set forth in claim 11, wherein the instructions, when executed, cause the programmable circuitry to pause model adaptations of the machine learning after the abnormal state is detected.

13. The non-transitory machine readable storage medium as set forth in claim 1, wherein the instructions, when executed, cause the programmable circuitry to output a recommendation regarding a change to the controller.

14. The non-transitory machine readable storage medium as set forth in claim 1, wherein the instructions, when executed, cause the programmable circuitry to detect, based on the machine learning, that at least one of an alarm limit or a set point should be modified.

15. A method comprising:
collecting a measurement of an operation of a process;
utilizing machine learning based on a state of the process and a goal function that references one or more measurement(s); and
modifying operation of a controller based on the machine learning.

16. The method as set forth in claim 15, wherein modifying operation of the controller includes adjusting tuning parameters for a proportional-integral-derivative controller.

17. The method as set forth in claim 15, wherein the machine learning includes at least one of any type of machine learning algorithm, any type of controller tuning, results from a large language model (LLM), or a reinforcement learning.

18. The method as set forth in claim 15, wherein the controller is a fuzzy logic controller.

19. The method as set forth in claim 15, wherein the controller is a machine learning controller that executes a machine learning model to control the operation of the process.

20. The method as set forth in claim 15, wherein the controller is a proportional-integral-derivative controller.
